(19) United States
(12) Patent Application Publication
(10) Pub. No.: US 2004/0095139 A1
(43) Pub. Date: May 20, 2004

(54) Magnetic resonance spectroscopy

(76) Inventor: Mark Allen Brown, Durham, NC (US)

Correspondence Address: FISH & RICHARDSON PC, 225 FRANKLIN ST, BOSTON, MA, 02110, US

(21) Appl. No.: 10/346,518

(22) Filed: Jan. 17, 2003

Related U.S. Application Data
(60) Provisional application No. 60/427,641, filed on Nov. 19, 2002.

(51) Int. Cl. G01V 3/00

(52) U.S. Cl. 324/309; 324/307

(57) ABSTRACT

Magnetic resonance signals that are measured by phase-array coils are combined in the time domain. The phase of the signal measured at each coil is adjusted in the time domain prior to combination with the signals measured at other coils so that the phase of the signals are substantially equal to one another. The combined time domain signal is then converted into a frequency domain signal for spectroscopic analysis.

### RELATED APPLICATIONS

This application claims the priority of U.S. Provisional Patent Application No. 60/427,641, filed on Nov. 19, 2002, entitled “Magnetic Resonance Spectroscopy,” the contents of which are hereby incorporated by reference into this application as if set forth herein in full.

### TECHNICAL FIELD

This invention relates to magnetic resonance spectroscopy.

### BACKGROUND

Magnetic resonance spectroscopy uses the magnetic resonance phenomenon to study physical, chemical, and biological properties of matter. An object to be examined is placed in a magnetic field, and a pulsed radio frequency (RF) signal is directed towards a volume within the object to induce magnetic resonance. The magnetic resonance signal can be detected by a measurement coil placed in the vicinity of the volume. The magnetic resonance signal resembles a sine wave having a frequency ω that decays with a time constant, and is referred to as a free induction decay (FID) signal. Different types of atoms in the volume will cause different magnetic resonance frequencies ω. By examining the spectrum of the FID signals, it is possible to determine the type of atoms contained in the volume.

In general, the amplitudes of FID signals are weak. When a single measurement coil is used, the signals detected by the coil may not be strong, and may be corrupted by noise. An array of coils, referred to as a “phased-array coil,” can be used to measure the magnetic resonance signals and increase the signal-to-noise ratio. In the past, the FID signal detected at each coil element of the phased-array coil is individually converted into a frequency domain signal. The resulting frequency domain signals are combined to generate a combined signal in the frequency domain that has a higher signal-to-noise ratio than the component signals.

### SUMMARY

In general, in one aspect, the invention is directed towards a method of magnetic resonance spectroscopy that includes applying a radio frequency pulse to induce magnetic resonance in a volume; using a first coil to detect a first time domain signal representing the induced magnetic resonance; using a second coil to detect a second time domain signal representing the induced magnetic resonance; adjusting the phase of the second time domain signal to generate a phase-corrected time domain signal so that the phase of the phase-corrected second time domain signal is substantially equal to the phase of the first time domain signal; and combining the first time domain signal with the phase-corrected second time domain signal to generate a combined time domain signal.

In general, in another aspect, the invention is directed towards a method of magnetic resonance spectroscopy that includes measuring time domain magnetic resonance signals using a plurality of coils; adjusting the phase of the time domain magnetic resonance signals to a common reference; and combining the adjusted time domain magnetic resonance signals.

In general, in another aspect, the invention is directed towards a method of magnetic resonance spectroscopy that includes receiving magnetic resonance signals at a plurality of coils, each signal having a phase and an amplitude; adjusting the phase of the magnetic resonance signals in the time domain to generate phase compensated signals; and combining the phase compensated signals to generate a combined signal.

Implementations of the invention may include one or more of the following features. A frequency spectrum of the combined time domain signal is determined. Adjusting the phase includes compensating the phase differences between the magnetic resonance signals in the time domain to generate phase compensated signals so that the phase of the phase compensated signals are substantially equal to one another. Each coil has a particular sensitivity, and the method further includes weighting each of the magnetic resonance signals according to a weighting factor that is based on the sensitivity of the corresponding coil. The method includes determining the sensitivity of each coil by measuring background noise when there is no magnetic resonance signal. The magnetic resonance signal includes a free induction decay signal. The method includes establishing a polarizing magnetic field in a region and applying a radio frequency pulse to induce magnetic resonance in a volume (e.g., including human tissue) in the region to generate magnetic resonance signals. The magnetic resonance signal Sₙ(t) received at an n-th coil can be represented as: Sₙ(t)=Aₙexp(iφ_{ref}+iδφₙ)exp[it(ω−1/T₂)], where Aₙ is an amplitude coefficient, φ_{ref} is the phase of a reference signal, δφₙ is the difference between the phase of the signal received at the n-th coil and the phase of the reference signal, ω is the frequency of the magnetic resonance signals, and T₂ is the spin-spin relaxation time. The combined signal S_{T}(t) can be represented as:

$${S}_{T} ( t ) = {\sum }_{n = 1 … N} [ {w}_{n} \cdot {A}_{n} ] \cdot exp ( {ⅈφ}_{ref} ) exp [ ⅈ t ( ω - 1 / {T}_{2} ) ] ,$$

where N is the number of coils, and wₙ is a weighting coefficient determined by the sensitivities of each coil. Adjusting the phase includes selecting one of the magnetic resonance signals as a reference signal, and adjusting the phase of the magnetic resonance signals other than the reference signal so that the phases of the magnetic resonance signals are substantially equal to the phase of the reference signal.

In general, in another aspect, the invention is directed towards an apparatus for magnetic resonance spectroscopy that includes a magnet for producing a magnetic field; a support for supporting an object in the magnetic field; a radio frequency signal generator for generating a radio frequency pulse to excite a volume in the object to generate a magnetic resonance signal; at least two coils for detecting the magnetic resonance signals; and a data processor for processing the magnetic resonance signals detected by the at least two coils, the data processor performing the steps of adjusting the phase of the magnetic resonance signals in the time domain to generate phase-compensated signals, combining the phase-compensated signals in the time domain to generate a combined signal, and determining the frequency spectrum of the combined signal.

Implementations of the invention may include one or more of the following features. The data processor adjusts the phases of the phase-compensated signals so that the phases of the phase-compensated signals are substantially equal to one another. At least two coils do not completely overlap and are placed in a vicinity of the object. The object comprises live tissues.

In general, in another aspect, the invention is directed towards an apparatus for magnetic resonance spectroscopy that includes means for exciting a volume to generate a magnetic resonance signal; at least two coils for detecting the magnetic resonance signals; and means for processing the magnetic resonance signals detected by at least two coils by adjusting the phase of each of the magnetic resonance signals in the time domain to generate phase-compensated signals, combining the phase-compensated signals in the time domain to generate a combined signal, and determining the frequency spectrum of the combined signal.

Implementations of the invention may include one or more of the following features. The exciting means comprises means for generating a magnetic field and means for generating a radio frequency pulse to excite the volume. The phase of the phase-compensated signals are substantially equal to one another.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a magnetic resonance spectrometry system.

FIG. 2 is a diagram showing an array of coils and a tissue volume.

FIG. 3 is a flowchart showing a process for generating a magnetic resonance spectrum by combining individual FID signals.

FIGS. 4A-15B are graphs showing measurement data.

FIG. 16 is a table showing measurement data.

Like reference symbols in the various drawings indicate like elements.

### DETAILED DESCRIPTION

The magnetic resonance spectroscopy system described herein matches the phases of FID signals measured by different coil elements of a phased-array coil, combines the phase-matched signals in the time domain, and computes the frequency spectrum of the combined signal to produce enhanced magnetic resonance spectroscopic signals with reduced Fourier transform computations.

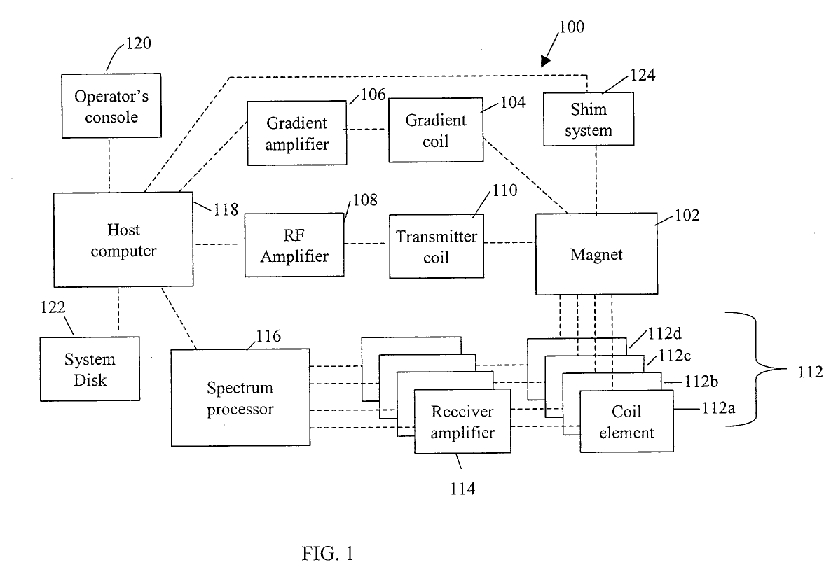

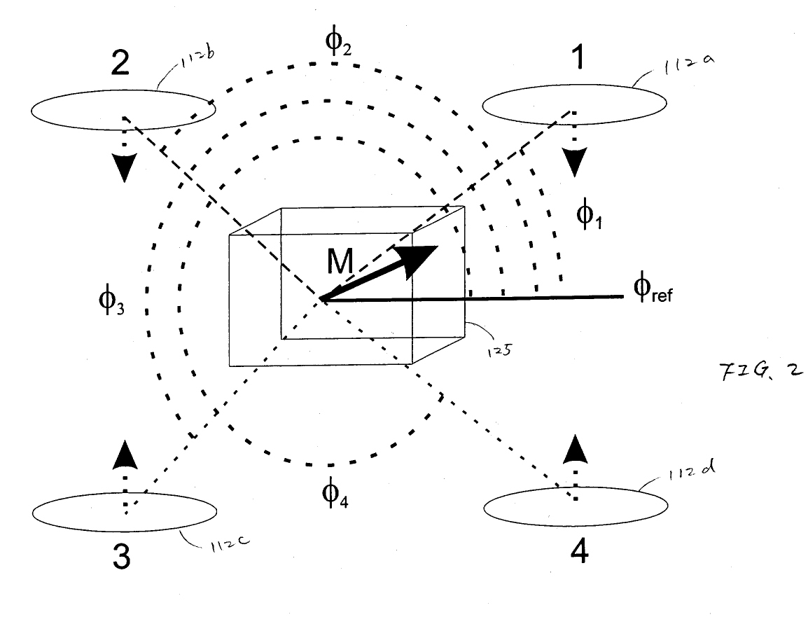

Referring to FIG. 1, a magnetic resonance spectrometry system 100 includes a magnet 102 that generates a substantially uniform, main magnetic field through an examination region where a patient body is located. Magnet 102 can be an electromagnet made of superconducting wire. A shim system 124 corrects minor spatial inhomogeneities in the main magnetic field at a portion of the patient body to be examined. A gradient coil 104 produces linear magnetic field gradients in the main magnetic field at a body portion in the examination region. A gradient amplifier 106 generates current that flows through gradient coil 104 to produce sufficient magnetic field gradient in the examination region. A radio frequency (RF) amplifier 108 generates an RF pulse that is transmitted by a transmitter coil 110 to the examination region. The RF pulse energizes atoms in the patient's body at the examination region.

The atoms in the body portion that are energized by the RF pulse emit FID signals (described above). The FID signals are detected by a phased-array receiver coil 112 that includes coil elements 112a-112d. The signals detected by receiver coil 112 are amplified by receiver amplifiers 114 and sent to spectrum processor 116, which generates a frequency spectrum of the body portion based on the signals detected by coil elements 112a-112d. Spectrum processor 116 combines the signals from the individual coil elements in the time domain to generate a combined signal. Spectrum processor 116 applies a Fourier transform to the combined signal to generate a frequency domain signal representing a spectrum of the magnetic resonance signal. Spectrum processor 116 forwards data representing the time domain signals and the corresponding frequency domain signal to host computer 118 for further analysis.

Different types of atoms in the body portion resonate at different frequencies in response to the RF pulse and emit FID signals that have different frequencies. By examining the spectrum of the FID signals, it is possible to determine the types of atoms in the body portion. This is useful in diagnosing whether certain ailments exist in the body portion.

In the example above, spectrum processor 116 combines the signals from different coil elements 112a-112d in the time domain and converts the combined signal into a frequency domain signal. It is also possible to configure the host computer 118 to perform processes for combining the time domain signals and converting the resulting combined signal into the frequency domain signal.

The shapes of RF pulses emitted by transmitter coil 110 influence the amount of energy applied to the atoms. A measurement process is defined by a pulse sequence, which controls the relative timing of the RF pulses and gradient pulses that are applied during the measurement to adjust the gradient of the magnetic field surrounding the body portion to be examined. Host computer 118 controls the gradient amplifier 106 to generate the gradient pulses. Host computer 118 controls RF amplifier 108 to adjust the pulse shapes and sequence of the RF pulses. A storage system, here a system disk 122, stores the time domain data and the spectrum data sent from the spectrum processor 116. An operator's console 120 displays the spectrum of the combined signal. Console 120 also allows an operator to enter commands to control the host computer 118.

Referring to FIG. 2, a volume of tissue 125 having atoms that are excited by the RF pulses emits an FID signal that is detected by coil elements 112a-112d. The coil elements do not completely overlap and are placed in the vicinity of tissue 125. The atoms in the volume of tissue 125 combine to form a net magnetization M. The FID signal produced by the net magnetization M from the volume of tissue can be expressed as:

S(t)=Aexp(iφ)exp[it(ω−1/T₂)], (Eq. 1)

where A is the amplitude of the signal, φ is the phase angle relative to a reference phase, ω is the frequency of the signal, and T₂ is the spin-spin relaxation time. The T₂ relaxation time is a characteristic decay time of the net magnetization M from the volume of tissue 125. The T₂ relaxation time characterizes the intermolecular interactions between the spins within the volume of tissue 125 that dephase the molecular motions and produce a signal loss in the receiver coil 112.

Each coil element (112a-112d) in the phased-array receiver coil 112 individually measures the signal from tissue volume 125 and generates a time domain signal. These signals are combined to produce a stronger signal with a higher signal-to-noise ratio. When combining these signals, two factors are taken into consideration: (1) The signals are compensated to account for different coil sensitivities, which may be caused by manufacturing tolerances. If equal gains are used for all coil elements, then a coil element with a greater sensitivity will have a greater significance in the combined signal than is appropriate. (2) The signals are matched in phase prior to combination. Failure to correct phase can cause one signal to cancel out another signal when the signals are combined.

Spectrum processor 116 processes signals measured by coil elements 112a-112d to compensate for different coil sensitivities and phase differences. To compensate for coil sensitivities, background noise is measured as an indicator of the sensitivities of the coil elements. Let Sₙ represent the FID signal measured by the n-th coil element in the array and σₙ represent the standard deviation of the background noise measured by the n-th coil element when there are no RF pulses. Spectrum processor 116 combines the signals by applying weighting factors wₙ derived from the background noise measurements:

S_{T}(t)=w₁·S₁(t)+w₂·S₂(t)+w₃·S₃(t)+w₄·S₄(t), (Eq. 2)

where

wₙ=σₙ/\sqrt{σ₂²+σ₂²+σ₃²+σ₄²} (Eq. 3)

are noise-normalized factors, assuming no mutual resistance between the coil elements.

To compensate for phase differences, the phase of the signal at each coil element is adjusted in the time domain prior to combination. The waveform of the FID signal detected by each of the coil elements 112a-112d is substantially identical (if noise and errors in measurement are not considered) except for constant phase differences among the signals. The constant phase differences can be caused by differences in the positions of the coil elements relative to the tissue volume, and other factors such as cable length differences or other hardware variables.

The constant phase differences between the signals at the coil elements 112a-112d can be determined by comparing the phases of signals from the coil elements at a particular time. For the purpose of illustration, assume that the phases of the signals at coil elements 112a-112d are φ₁, φ₂, φ₃, and φ₄, respectively. These phases are measured relative to a reference phase φ_{ref}. One of the signals may be selected as a reference signal, its phase used as the reference phase, and the other signals may be compared to the reference signal for phase correction. For example, the signal from coil element 112a may be selected as the reference signal. The phase of the signal at coil element 112b relative to the reference signal equals δφ₂=φ₂−φ_{ref}. Likewise, the phase of the signal at the n-th coil element relative to the signal at coil element 112a equals:

δφₙ=φₙ−φ_{ref}. (Eq. 4)

The signal Sₙ measured at each coil element can be represented as:

Sₙ(t)=Aₙexp(iδφₙ)exp[it(ω−1/T₂)], (Eq. 5)

which can be rewritten as:

Sₙ(t)=Aₙexp(iδφₙ)exp(iφ₁)exp[it(ω−1/T₂)]. (Eq. 6)

For a four-element phased-array coil, combining the signals by taking account of weighting factors wₙ in Eq. 2 but without phase compensation results in the following equation:

$${S}_{T} ( t ) = {w}_{1} \cdot {A}_{1} \cdot exp ( {ⅈδφ}_{1} ) \cdot exp ( {ⅈφ}_{ref} ) \cdot exp [ ⅈ t ( ω - 1 / {T}_{2} ) ] + {w}_{2} \cdot {A}_{2} \cdot exp ( {ⅈδφ}_{2} ) \cdot exp ( {ⅈφ}_{ref} ) \cdot exp [ ⅈ t ( ω - 1 / {T}_{2} ) ] + {w}_{3} \cdot {A}_{3} \cdot exp ( {ⅈδφ}_{3} ) \cdot exp ( {ⅈφ}_{ref} ) \cdot exp [ ⅈ t ( ω - 1 / {T}_{2} ) ] + {w}_{4} \cdot {A}_{4} \cdot exp ( {ⅈδφ}_{4} ) \cdot exp ( {ⅈφ}_{ref} ) \cdot exp [ ⅈ t ( ω - 1 / {T}_{2} ) ] = \\ [ {w}_{1} \cdot {A}_{1} \cdot exp ( {ⅈδφ}_{1} ) + {w}_{2} \cdot {A}_{2} \cdot exp ( {ⅈδφ}_{2} ) + {w}_{3} \cdot {A}_{3} \cdot exp ( {ⅈδφ}_{3} ) + {w}_{4} \cdot {A}_{4} \cdot exp ( {ⅈδφ}_{4} ) ] \times exp ( {ⅈφ}_{ref} ) \cdot exp [ ⅈ t ( ω - 1 / {T}_{2} ) ] = {\sum }_{n = 1 … 4} [ {w}_{n} \cdot {A}_{n} \cdot exp ( {ⅈδφ}_{n} ) ] \cdot exp ( {ⅈφ}_{ref} ) \cdot exp [ ⅈ t ( ω - 1 / {T}_{2} ) ] . \qquad ( Eq . 7 )$$

When the phase of the signal measured at each coil element is adjusted so that they match one another, the combined signal can be written as follows:

$${S}_{T} ( t ) = {w}_{1} \cdot {S}_{1} ( t ) \cdot exp ( - {ⅈδφ}_{1} ) + {w}_{2} \cdot {S}_{2} ( t ) \cdot exp ( - {ⅈδφ}_{2} ) + {w}_{3} \cdot {S}_{3} ( t ) \cdot exp ( - {ⅈδφ}_{3} ) + {w}_{4} \cdot {S}_{4} ( t ) \cdot exp ( - {ⅈδφ}_{4} ) . \qquad ( Eq . 8 )$$

Any of signals Sₙ(t) can be used as a reference signal. In Equations 6 and 8, if the signal S₁(t) measured at the first coil element is used as the reference signal, then δφₙ=φₙ−φ₁.

The resulting combined signal S_{T}(t) is converted into a frequency domain signal using a Fourier transform with subsequent phase correction and extraction of the real portion to determine the frequency spectrum of the magnetic resonance signal. Different peaks in the spectrum correspond to different molecules or portions of molecules. The frequency spectrum can be used to analyze the composition of the tissue volume for diagnostic purposes.

An advantage of combining signals from different coil elements in the time domain is that only one Fourier transformation is performed. Also, only one frequency domain phase correction is applied to the signals from each coil element. Fourier transformation and phase correction are time-consuming operations, so by reducing the number of Fourier transformation and phase correction operations that are required, magnetic resonance spectroscopic data may be obtained faster using less expensive data processors and requiring less user intervention.

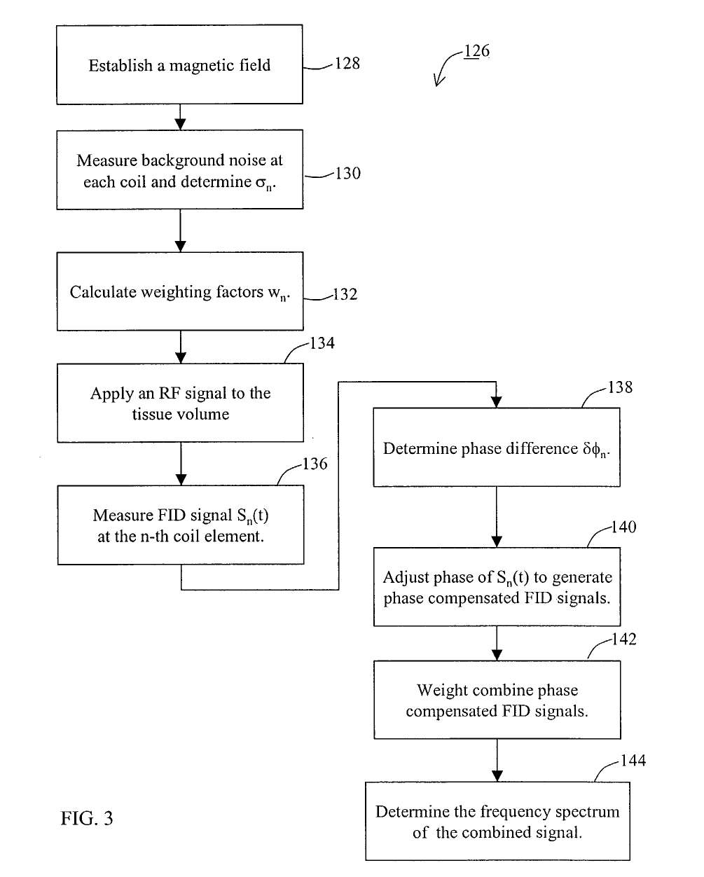

Referring to FIG. 3, a process 126 illustrates an example of generating a magnetic resonance spectrum by combining individual FID signals measured at each coil element in phased-array receiver coil 112 to increase the signal-to-noise ratio of the measurement.

In process 126, a magnetic field is established (128) using magnet 102 and gradient coil 104. Background noise is measured (130) at each coil while the RF amplifier 108 is turned off. Weighting factors wₙ are calculated (132) according to Eq. 3. An RF pulse is transmitted (134) using the transmitter coil 110 to energize the volume of tissue 125. The FID signal Sₙ(t) is measured (136) at each coil element. The phase differences δφₙ are determined (138). The phase of Sₙ(t) is adjusted (140) to generate phase compensated FID signals. Phase compensated FID signals are weight combined according to Eq. 7 (142) using weighting factors wₙ. A Fourier transform is applied (144) to the combined signal to generate the frequency spectrum of the combined signal.

Experiments were conducted using a four-element phased-array coil to detect FID signals from a sample volume in a plexiglass sphere 170 mm in diameter. The sphere contains sodium acetate and lithium lactate dissolved in water, each at a concentration of 0.1 molal. The sodium acetate and lithium lactate molecules contain hydrogen atoms that produce a single and double peak, respectively, in the frequency spectrum. The signal was measured from a sample volume 20 mm×20 mm×20 mm in size located within the sphere.

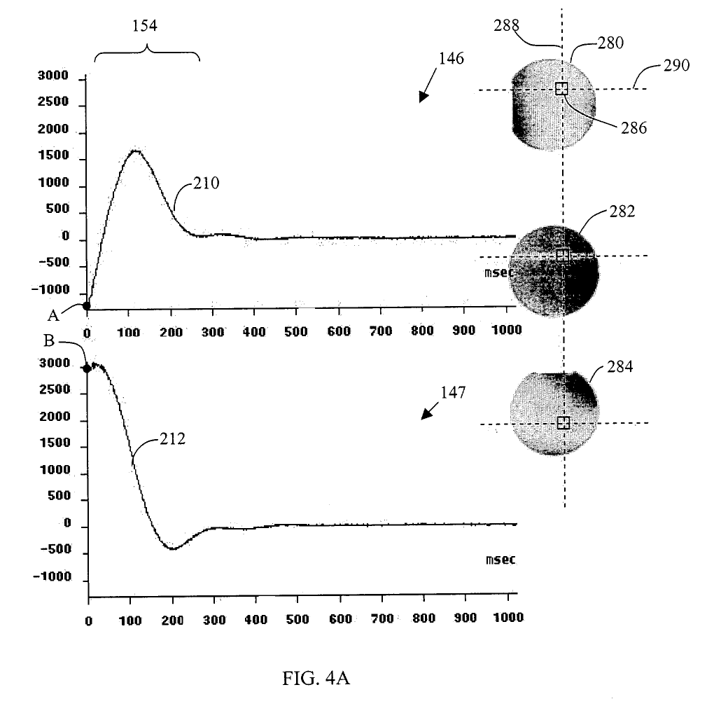

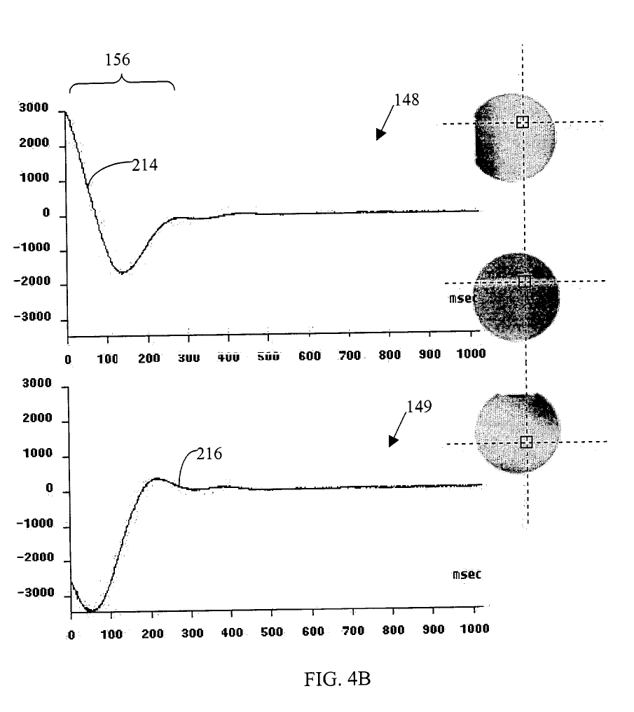

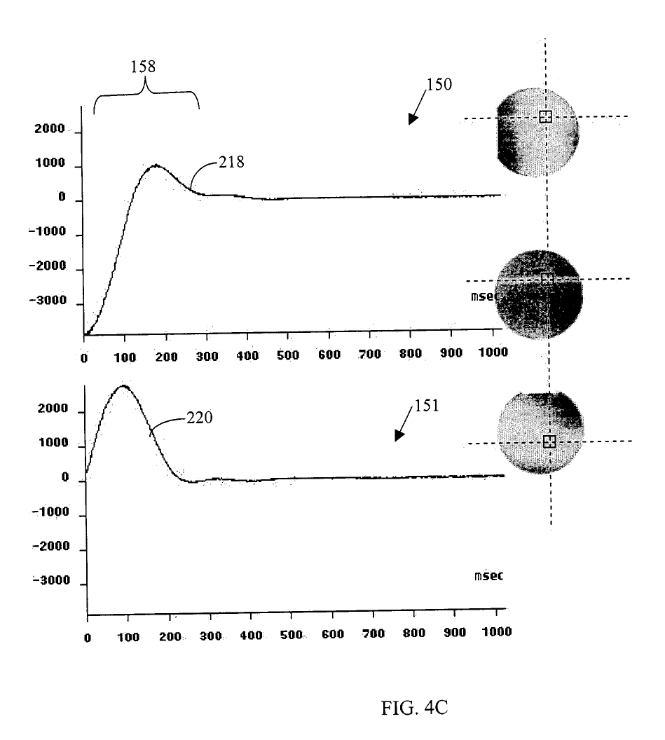

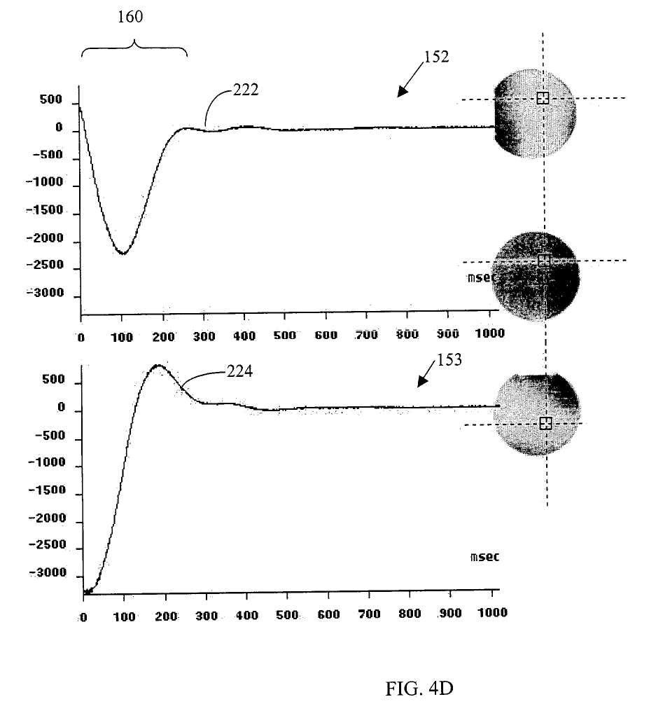

Referring to FIGS. 4A-4D, graphs 146-153 show signals measured from the sample volume. The right side of each figure shows a sagittal (top) image 280, a coronal (middle) image 282, and a transverse (bottom) image 284 of the sphere. A square 286 within each image represents the location of the sample volume. Dotted lines 288 and 290 bisecting each image are cross-reference lines indicating the position of the other two images.

The experiments included application of RF pulses to excite the atoms in the sample volume 286 and pausing a time period (referred to as “TE” time) of 135 milliseconds to begin the measurement process. For each coil element of the phased-array coil, the induced voltage (signal) was measured using a quadrature detector that generates two signals having a phase difference of 90 degrees. Mathematically, one signal corresponds to a real part of the FID signal, and the other signal corresponds to an imaginary part of the FID signal. For the measurement process, the signal was digitized with 1024 pairs of data points, real and imaginary. The excitation-pause-detection sequence was repeated 8 times with a time period (referred to as “TR” time) of 1500 milliseconds between successive excitations. The digitized signals measured for each sequence repetition for corresponding coil elements were added together.

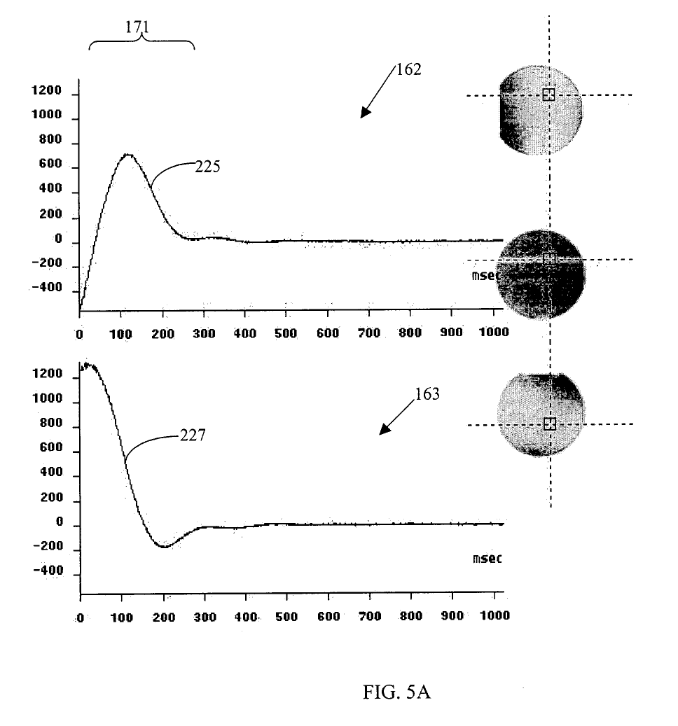

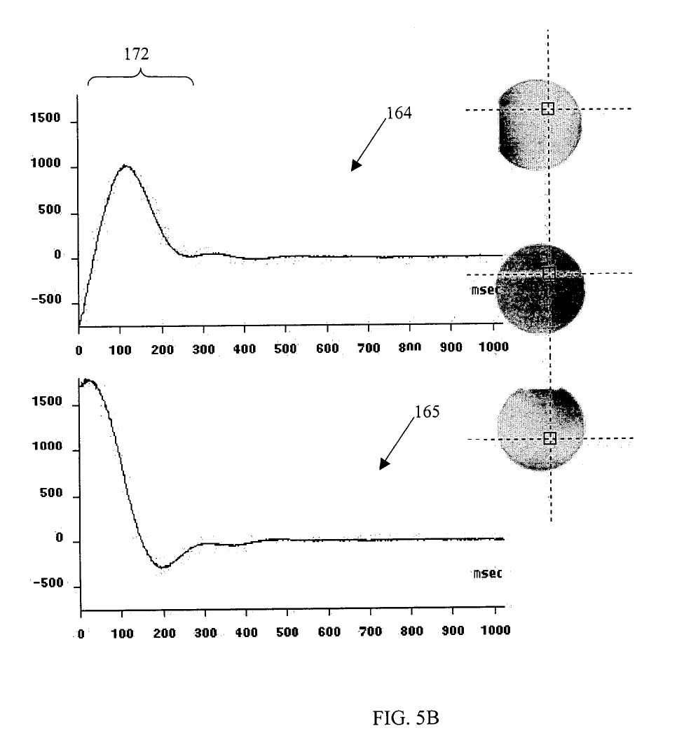

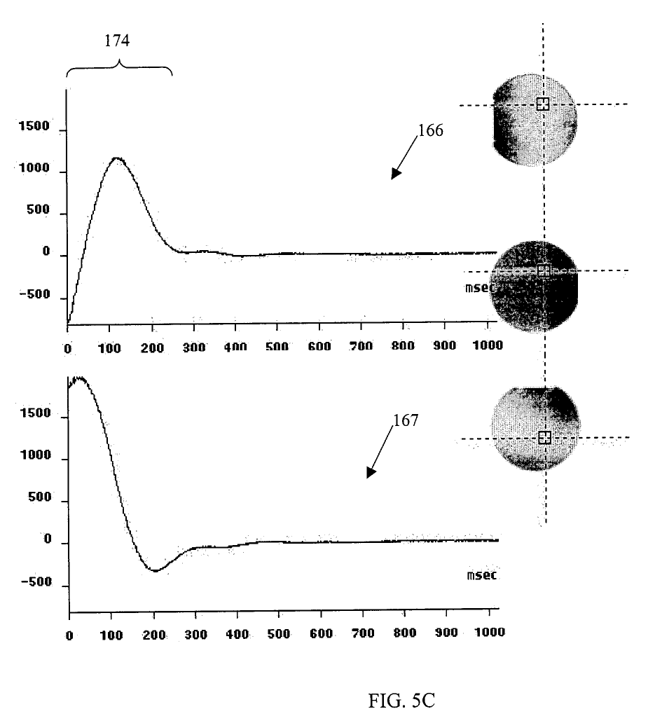

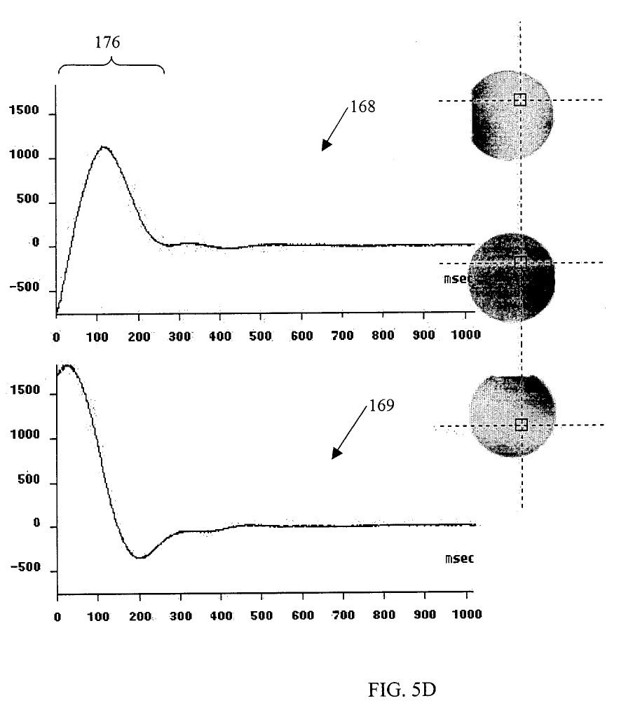

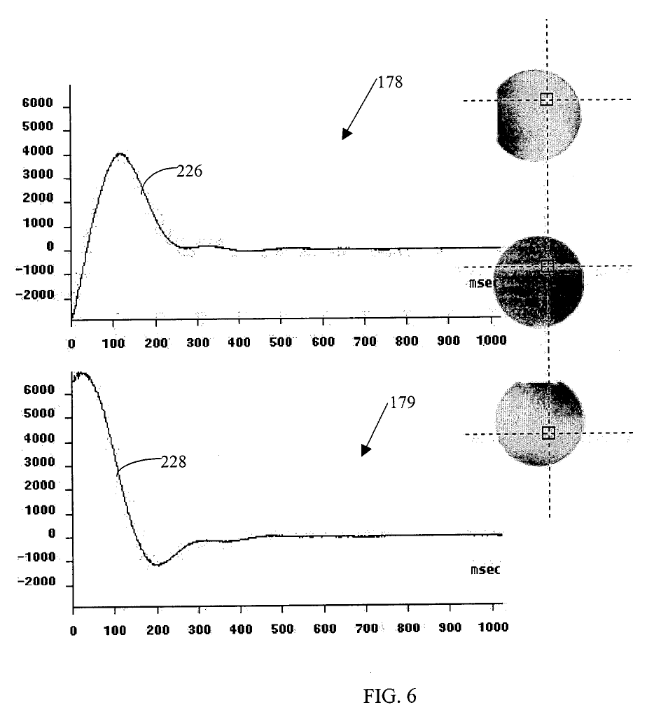

FIGS. 4A-4D show the FID signals measured by the four different coil elements. FIGS. 5A-5D show phase compensated FID signals derived from the measurements shown in FIGS. 4A-4D. FIG. 6 shows combined FID signals derived from data shwon in FIGS. 5A-5D. In each graph, the horizontal axis represents time in milliseconds, and the vertical axis represents signal amplitude in millivolts. In FIGS. 4A-4D, 5A-5D, and 6, on the horizontal axis, time=0 represents the start time of the detection process, which occurs at an operator-specified TE time following the RF excitation pulse. The data shown in FIGS. 4A-4D were measured using identical measurement parameters.

Referring to FIG. 4A, graphs 146 and 147 show measurements of FID signals from the first coil element using the quadrature detector. Lines 210 and 212 represent the real part and imaginary part, respectively, of the signal. Referring to FIG. 4B, graphs 148 and 149 show measurements of FID signals from the second coil element using the quadrature detector. Lines 214 and 216 represent the real part and imaginary part, respectively, of the signal. Referring to FIG. 4C, graphs 150 and 151 show measurements of FID signals from the third coil element using the quadrature detector. Lines 218 and 220 represent the real part and imaginary part, respectively, of the signal. Referring to FIG. 4D, graphs 152 and 153 show measurements of FID signals from the fourth coil element using the quadrature detector. Lines 222 and 224 represent the real part and imaginary part, respectively, of the signal. The beginning portions 154, 156, 158, and 160 of the graphs in FIGS. 4A-4D are quite different. These differences are mostly due to the differences in phase of the signals measured by each coil element.

FIGS. 5A-5D show noise-weighted phase compensated signals using the signals from the first coil element as a reference signal. Referring to FIG. 5A, graphs 162 and 163 represent noise-weighted signals obtained from the first coil element. Data points on lines 225 and 227 were derived by applying weighting factors (Eq. 3) to the data points on lines 210 and 212 (FIG. 4), respectively. The data points in FIG. 5A have the same phase as those in FIG. 4A. Referring to FIG. 5B, graphs 164 and 165 represent measurements from the second coil element after the signals are phase compensated and noise weighted so that the phases of the signals from the second coil element match the phases of the signals from the first coil element. Referring to FIG. 5C, graphs 166 and 167 represent measurements from the third coil element after the signals are phase compensated and noise weighted so that the phases of signals from the third coil element match the phases of the signals from the first coil element. Referring to FIG. 5D, graphs 168 and 169 represent measurements from the fourth coil element after the signals are phase compensated and noise weighted so that the phases of signals from the fourth coil match the phases of the signals from the first coil element.

The method used for phase matching the signals from the n-th coil element to the signal from the first coil element is described below. Each measurement (represented by a data point on, e.g., line 214 or 216 in FIG. 4B) of the complex time signal from the n-th coil element was multiplied by a phase correction factor, exp(iδφₙ), where δφₙ=φₙ−φ_{ref}, as defined in Eq. 4. In the experiments, the signal from the first coil element was used as the reference signal, thus, δφₙ=φₙ−φ₁. The phase angle φₙ was calculated as the inverse tangent angle from the first time domain data point:

φₙ=tan⁻¹(Imag₁ₙ/Real₁ₙ) (Eq. 9)

where Real₁ₙ and Imag₁ₙ are the real and imaginary values of the first time domain complex data point for the n-th coil element. For example, the phase angle φ₁ can be calculated from the first data points A and B (at time=0 on lines 210 and 212, respectively) in FIG. 4A. Data point A has a value of −1300, data point B has a value of 2926, so φ₁=tan⁻¹(2926/(−1300))=−66 degrees.

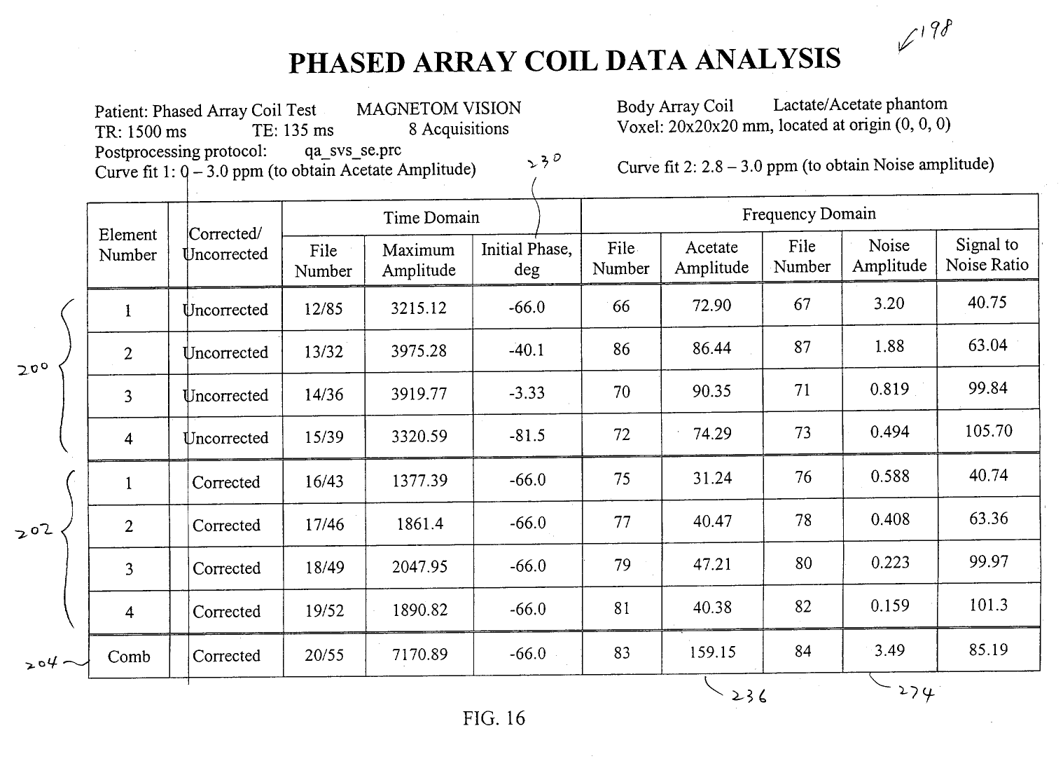

The phase angles φₙ were calculated for the first, second, third, and fourth coil elements, and their values are listed in column 230 of FIG. 16. These numbers were used in Eq. 4 to calculate phase differences δφₙ, which were used to calculate the phase correction factors, exp(iδφₙ). The graphs in FIGS. 5A-5D have initial data regions 171, 172, 174, and 176, respectively. Comparison of graphs 162, 163, and 164-169 shows that, after phase correction, the initial data regions 171, 172, 174, and 176 of each graph are very similar. This shows that the signals measured by different coil elements represent the same FID signal emitted from the sample volume.

Referring to FIG. 6, graphs 178 and 179 show the combined time domain signals derived from data shown in FIGS. 5A-5D. Lines 226 and 228 represent the real part and imaginary part, respectively, of the combined time domain signal. The magnitudes of the combined signals represented by lines 226 and 228 are stronger than corresponding signals shown in FIGS. 4A-4D. This demonstrates that combining FID signals using Eq. 8 can increase signal strength, resulting in a higher signal-to-noise ratio.

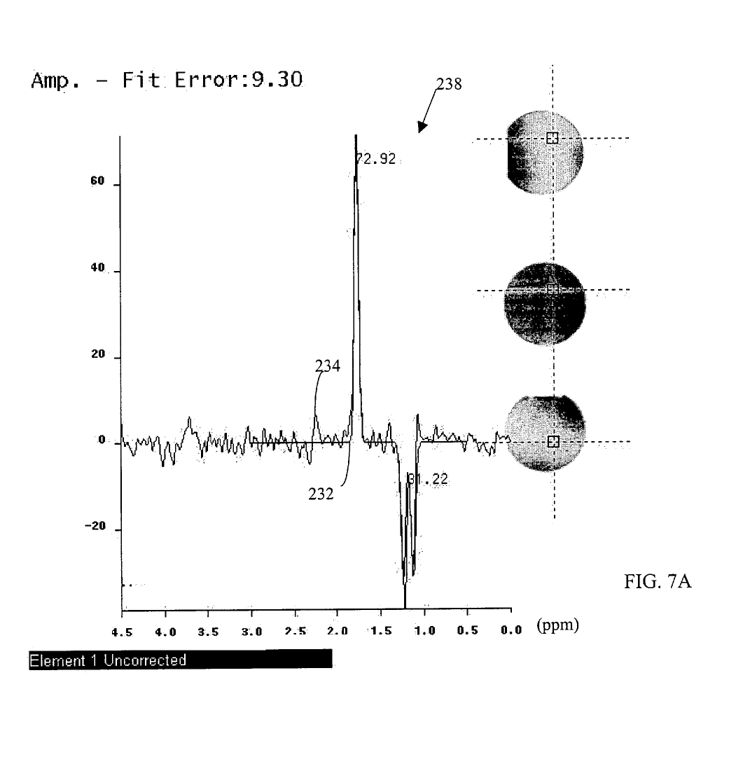

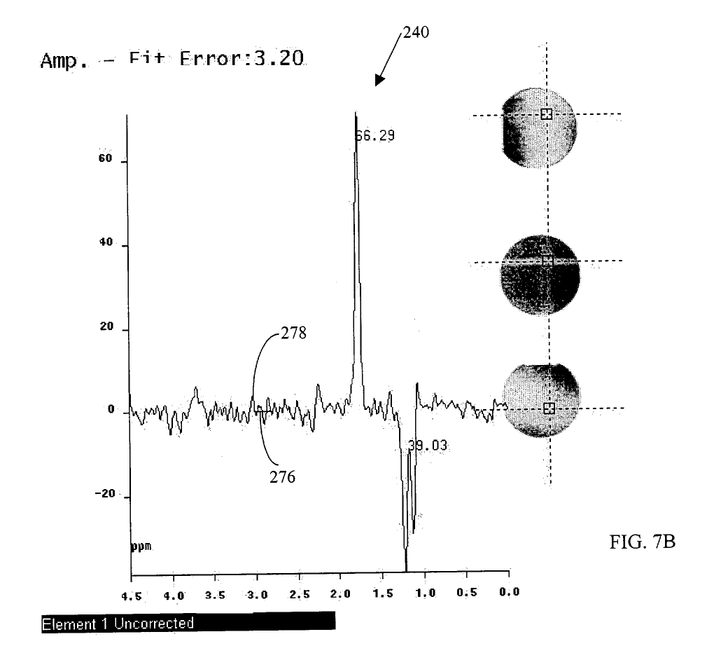

FIGS. 7A-15B show the real portion of processed frequency domain spectra obtained from the data shown in FIGS. 4A-6. All data were processed with identical parameters and in identical fashions, with the exception of the phase compensation method described above.

Referring to FIGS. 7A, 8A, 9A, 10A, 11A, 12A, 13A, 14A, and 15A, each of graphs 238, 242, 246, 250, 254, 258, 262, 264, and 270 shows a smooth line (e.g., 232 in FIG. 7A) superimposed on a jagged line (e.g., 234) between frequency 0.5 to 3.0 ppm. The smooth line represents a theoretical graph of the acetate and lactate hydrogen signals, and the jagged line represents the measured data. The horizontal axis represents frequency that increases from right to left, and the unit is parts per million (ppm), using a standard frequency as reference. On the horizontal axis, frequency 0.0 ppm is equal to the reference frequency 63,633,351 Hz, which represents the resonant frequency of a compound (tetramethylsilane) that is not found in the sample volume used in the experiments. Frequency 3.0 ppm is equal to 63,633,459 Hz.

In FIG. 7A, the number “72.92” beside the positive peak represents the acetate peak amplitude resulting from the theoretical curve fit, and is used to represent the signal amplitude measured from the spectrum. Column 236 in FIG. 16 summarizes the peak amplitudes of the positive peaks shown in FIGS. 7A, 8A, 9A, 10A, 11A, 12A, 13A, 14A, and 15A.

Referring to FIGS. 7B, 8B, 9B, 10B, 11B, 12B, 13B, 14B, and 15B, each of graphs 240, 244, 248, 252, 256, 260, 264, 268, and 272 shows a smooth line (e.g., 276 in FIG. 7B) superimposed on a jagged line (e.g., 278) between frequency 2.8 ppm and 3.0 ppm. The smooth line represents a theoretical graph of the signal; the jagged line represents the measured signal. The “fit error” (e.g., 3.20 in FIG. 7B) shown on the upper left portion of each graph represents the fit error resulting from the theoretical curve fit, and is used to represent the noise amplitude measured from the spectrum. The values of the noise amplitudes are summarized in column 274 of FIG. 16.

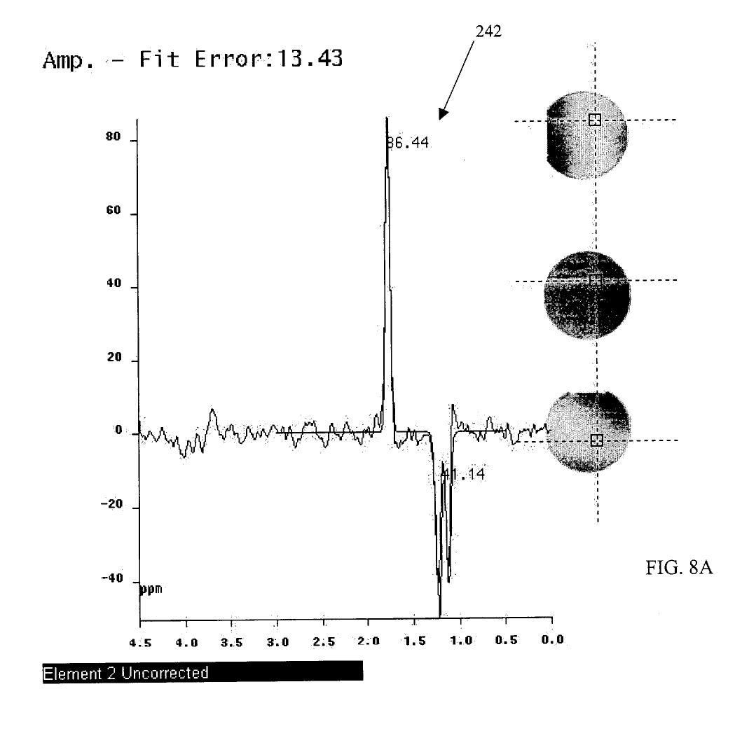

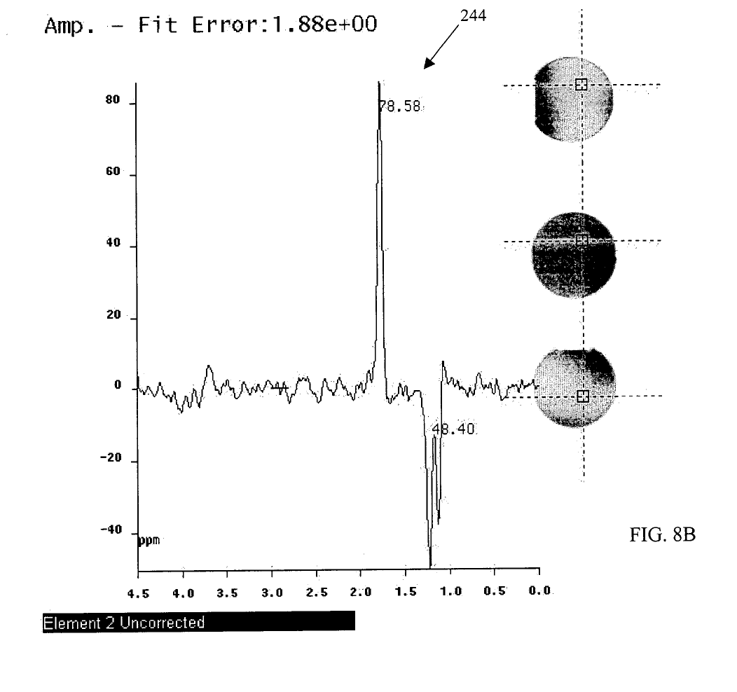

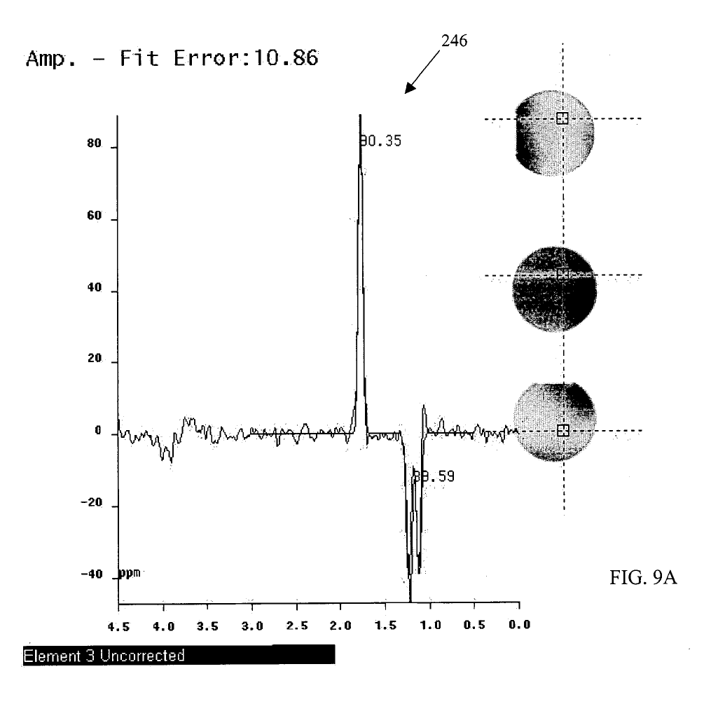

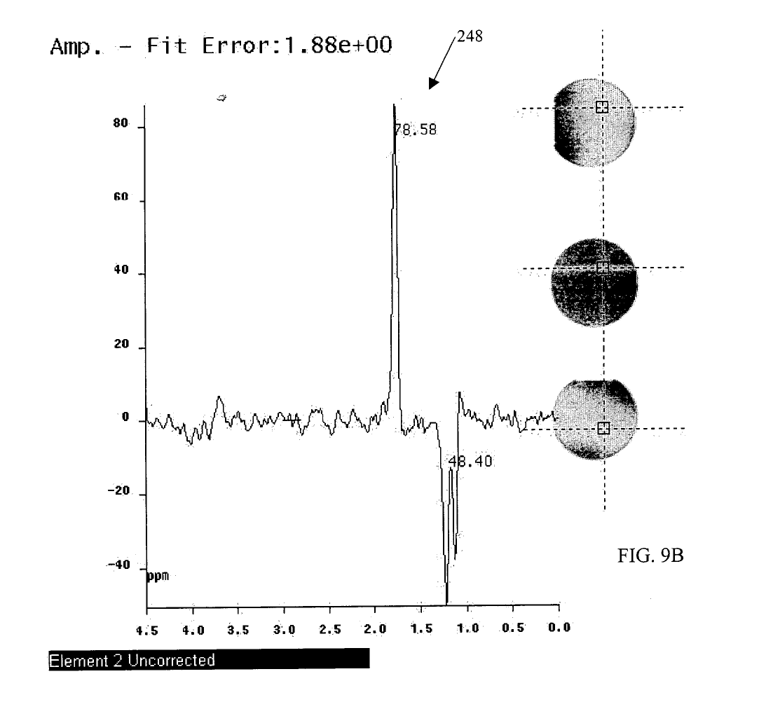

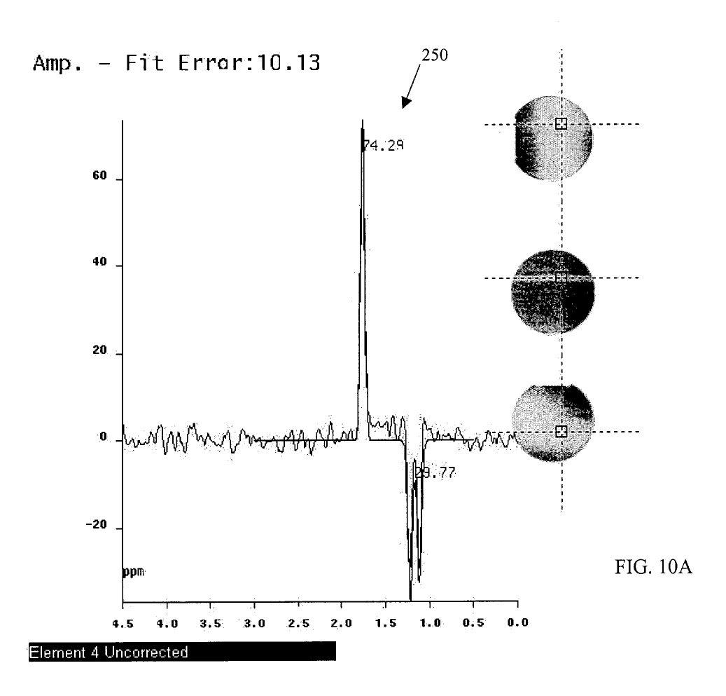

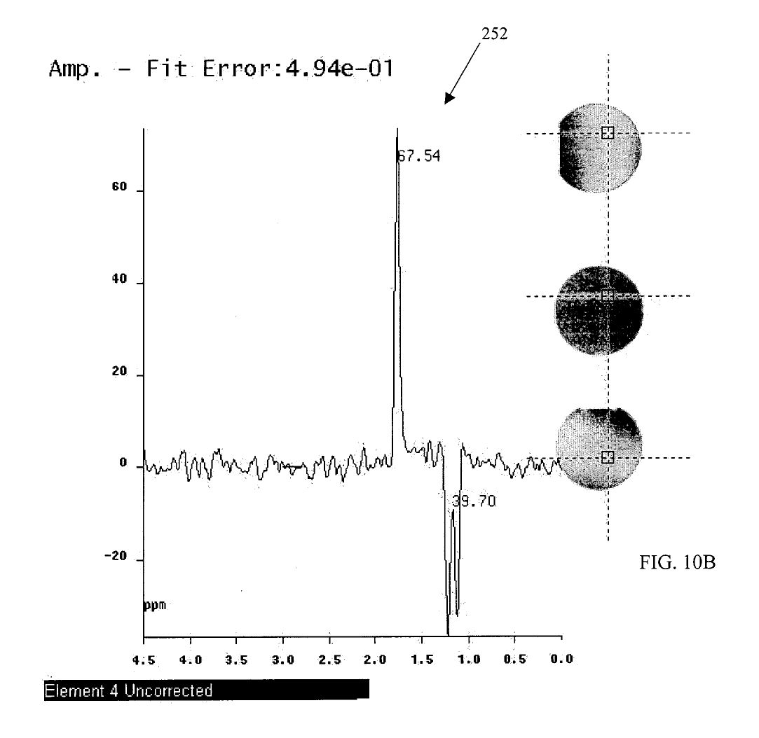

In FIGS. 7A-10B, graphs 238-252 represent frequency domain spectra converted directly from time domain data obtained from the four coil elements without phase compensation. In FIGS. 7A-7B, graphs 238 and 240 show the frequency domain spectra of the signals in graphs 146-147 of FIG. 4A. In FIGS. 8A-8B, graphs 242-244 show the frequency domain spectra of the signals in graphs 148-149 of FIG. 4B. In FIGS. 9A-9B, graphs 246-248 show the frequency domain spectra of the signals in graphs 150-151 of FIG. 4C. In FIGS. 10A-10B, graphs 250-252 show the frequency domain spectra of the signals in graphs 152-153 of FIG. 4D. The amplitudes and fit errors in FIGS. 7A-10B have not been corrected for coil differences.

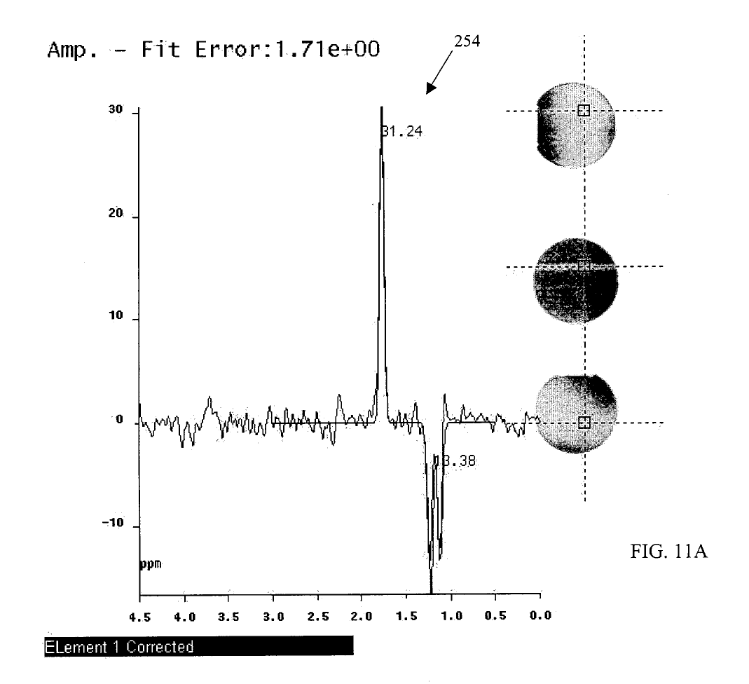

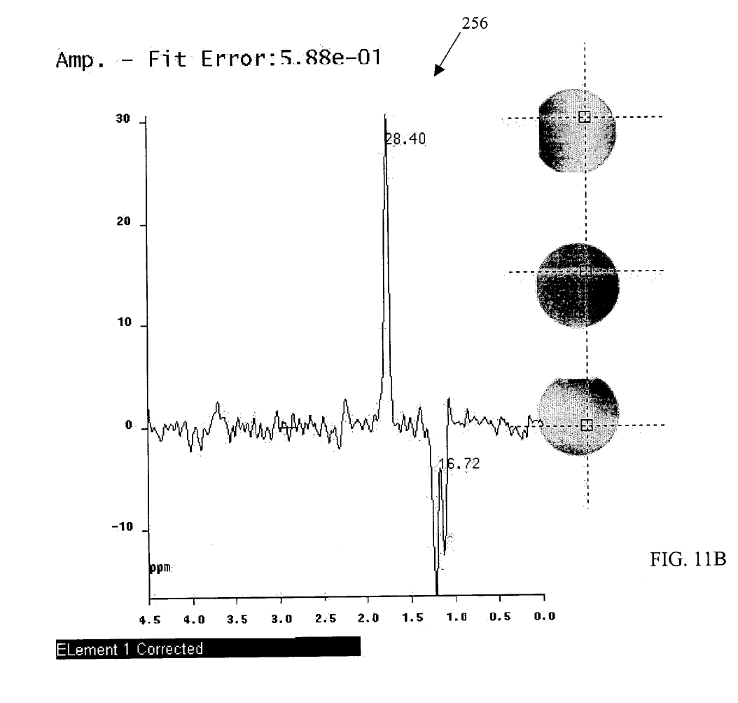

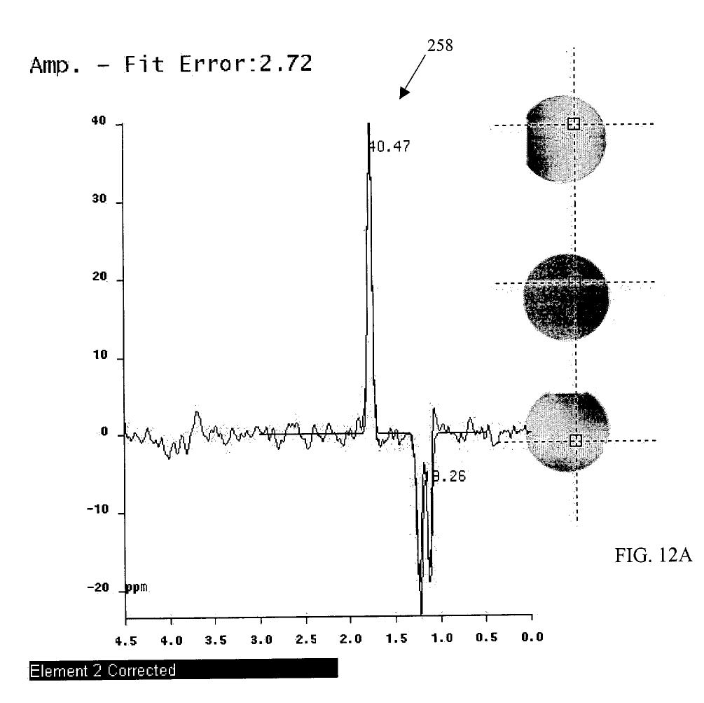

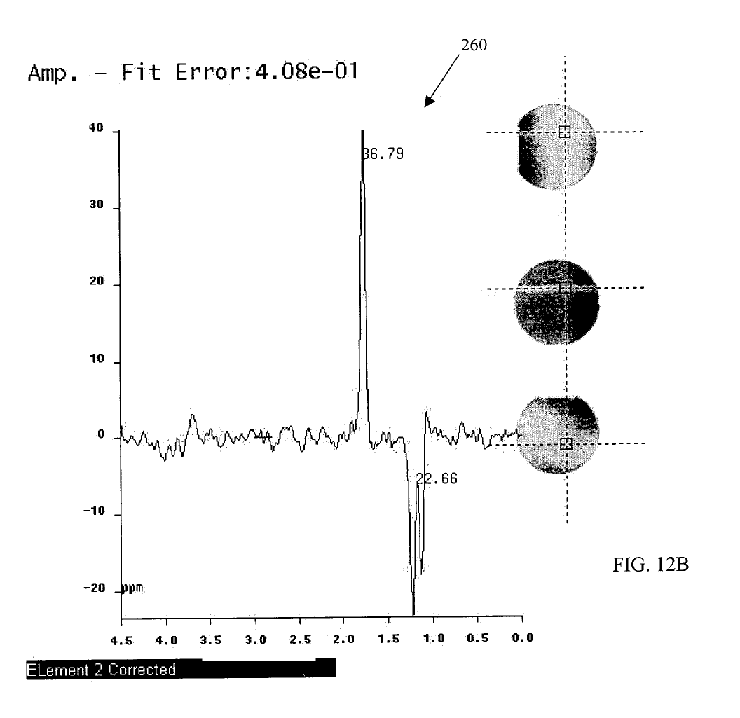

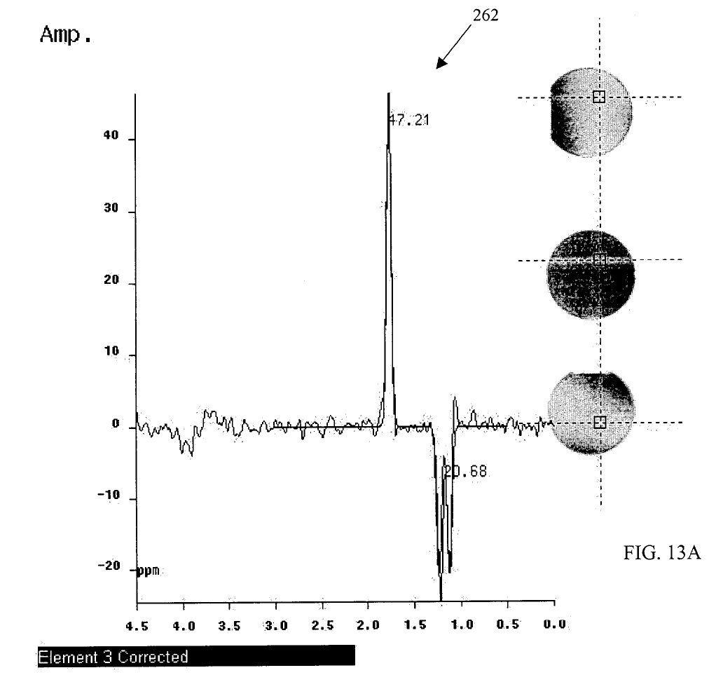

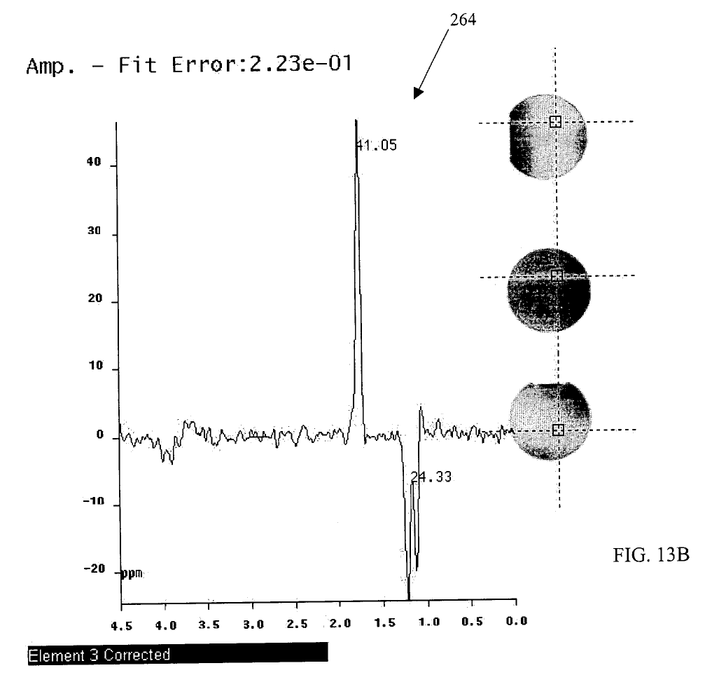

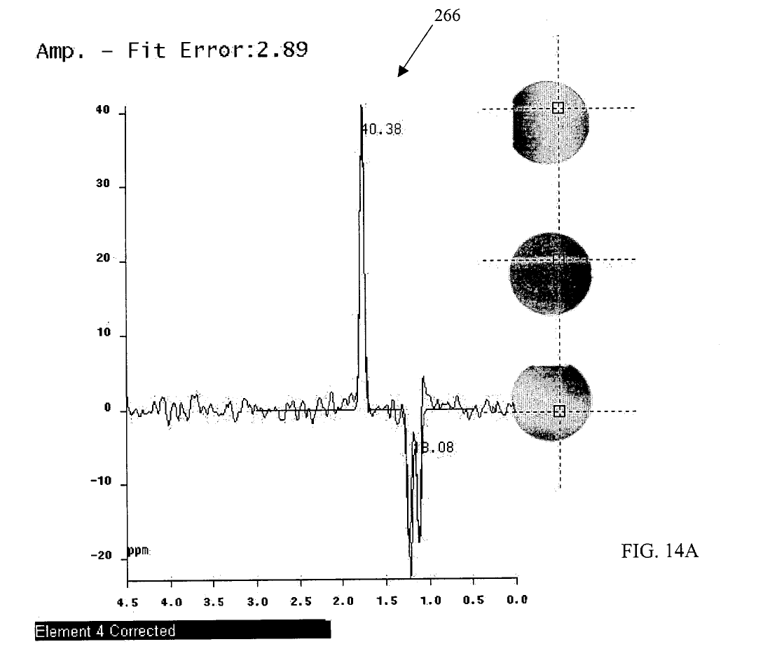

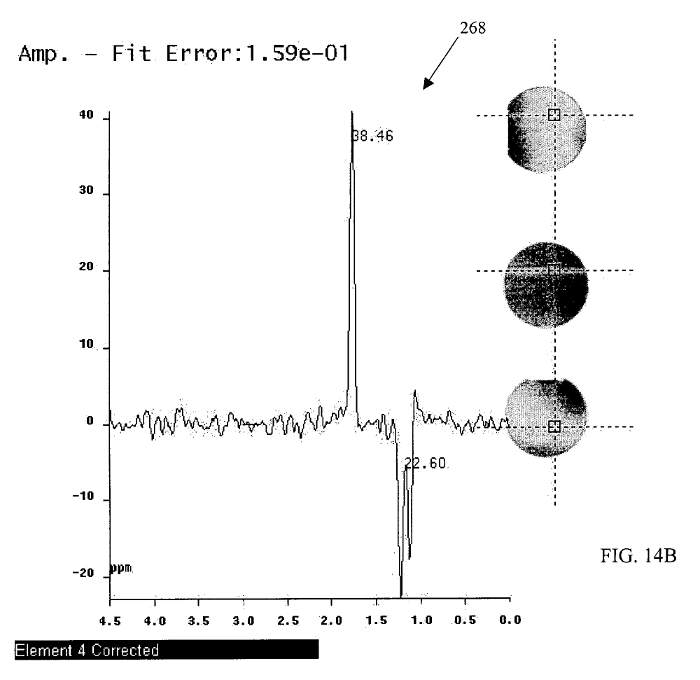

In FIGS. 11A-14B, graphs 254-268 represent frequency domain spectra from corrected time domain data for the four coil elements. In FIGS. 11A-11B, graphs 254-256 show the frequency domain spectra of the signals in graphs 146-147 of FIG. 5A. In FIGS. 12A-12B, graphs 258-260 show the frequency domain spectra of the signals in graphs 164-165 of FIG. 5B. In FIGS. 13A-13B, graphs 262-264 show the frequency domain spectra of the signals in graphs 166-167 of FIG. 5C. In FIGS. 14A-14B, graphs 266-268 show the frequency domain spectra of the signals in graphs 168-169 of FIG. 5D. The amplitudes and fit errors have been corrected for coil differences.

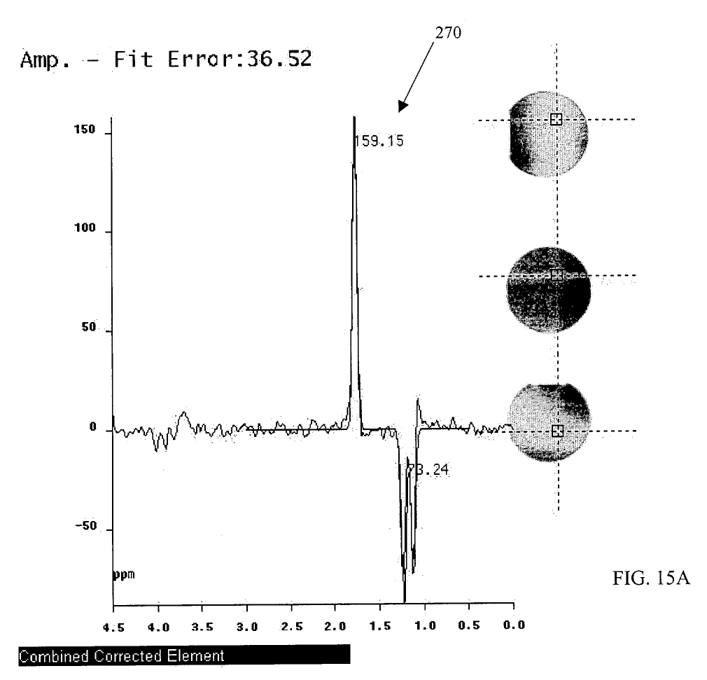

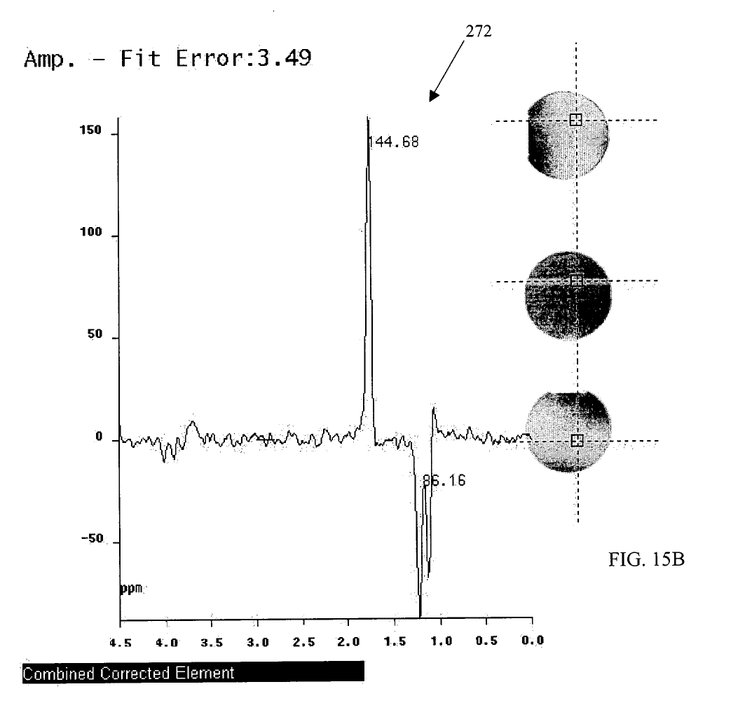

Referring to FIGS. 15A-15B, graphs 270-272 show the frequency domain spectra of the combined signals shown in FIG. 6. The magnitudes of the signal in graph 270 is stronger than corresponding signals in graphs 254 (FIG. 11A), 258 (FIG. 12A), 262 (FIG. 13A), and 266 (FIG. 14A). The magnitudes of the signal in graph 272 is stronger than corresponding signals in graphs 256, 260, 264, and 268.

Referring to FIG. 16, a table 198 shows the maximum amplitude and phase of the signals measured by the four coil elements. Columns 200 represent measurements from the four coil elements without phase compensation. Columns 202 represent measurements from the four coil elements with phase compensation. Column 204 represents combined measurements from the four coil elements with phase compensation. The measurements in column 204 show that a stronger signal strength can be achieved by phase correcting the time domain signals from each coil element and then combining them in the time domain.

Process 126 may be implemented using hardware, software, or a combination of the two. Process 126 may be implemented using computer programs executing on host computer 118 or other machines that each include a processor, a storage medium readable by the processor (including, but not limited to, volatile and non-volatile memory and/or storage components).

Each such program may be implemented in a high level procedural or object-oriented programming language to communicate with host computer 118. However, the programs can be implemented in assembly or machine language. The language may be a compiled or an interpreted language.

Each computer program may be stored on a storage medium or other article of manufacture (e.g., CD-ROM, hard disk, or magnetic diskette) that is readable by a general or special purpose programmable computer for configuring and operating the computer when the storage medium or device is read by the computer to implement the process. Process 126 may also be implemented as a machine-readable storage medium, configured with a computer program, where, upon execution, instructions in the computer program cause a machine to operate to determine the frequency spectrum of the combined signal.

A number of embodiments have been described. Nevertheless, it will be understood that various modifications may be made without departing from the spirit and scope of the invention. For example, magnetic resonance signals other than FID signals may be combined by phase correction in the time domain prior to combination. In the description relating to FIGS. 5A-5D, the reference phase used for phase compensation was calculated from the signal measured at the first coil element. This reference phase may also be calculated from a measurement obtained from a separate scan. Different ways of measuring background noise and calculating weighting factors may be used. Accordingly, other embodiments are within the scope of the following claim.

What is claimed is:

1. A method comprising:
applying a radio frequency pulse to provide induced magnetic resonance in a volume;
using a first coil to detect a first time domain signal representing the induced magnetic resonance;
using a second coil to detect a second time domain signal representing the induced magnetic resonance;
adjusting a phase of the second time domain signal to generate a phase-corrected time domain signal so that a phase of the phase-corrected time domain signal is substantially the same as a phase of the first time domain signal; and
generating a combined time domain signal based on the first time domain signal and the phase-corrected time domain signal.

2. The method of claim 1, further comprising determining a frequency spectrum of the combined time domain signal.

3. A method comprising:
measuring time domain magnetic resonance signals using a plurality of coils;
adjusting phases of the time domain magnetic resonance signals to produce phase adjusted time domain magnetic resonance signals; and
generating a combined time domain signal based on the phase adjusted time domain magnetic resonance signals.

4. The method of claim 3, further comprising:
determining a frequency spectrum of the combined time domain signal.

5. A method comprising:
receiving magnetic resonance signals at a plurality of coils, each magnetic resonance signal having a phase and an amplitude;
adjusting phases of the magnetic resonance signals in the time domain to generate phase compensated signals; and
generating a combined signal based on the phase compensated signals.

6. The method of claim 5, further comprising:
determining a frequency spectrum of the combined signal.

7. The method of claim 5, wherein adjusting the phase comprises compensating for phase differences between the magnetic resonance signals in the time domain so that phases of the phase compensated signals are substantially the same.

8. The method of claim 5, wherein each coil has a particular sensitivity, and the method further comprises weighting each of the magnetic resonance signals according to a weighting factor that is based on a sensitivity of a corresponding coil.

9. The method of claim 8, further comprising:
determining a sensitivity of each coil by measuring background noise when there is no magnetic resonance signal.

10. The method of claim 5, wherein the magnetic resonance signal comprises a free induction decay signal.

11. The method of claim 5, further comprising:
establishing a polarizing magnetic field in a region; and
applying a radio frequency pulse to induce magnetic resonance in a volume in the region to generate the magnetic resonance signals.

12. The method of claim 11, wherein the volume comprises human tissue.

13. The method of claim 5, wherein a magnetic resonance signal Sₙ(t) received at an n-th of the plurality of coils is defined by:
Sₙ(t)=Aₙexp(iφ_{ref}=iδφₙ)exp[it(ω−1/T₂)],
where Aₙ is an amplitude coefficient, φ_{ref} is a phase of a reference signal, δφₙ is a difference between a phase of the signal received at the n-th coil and the phase of the reference signal, ω is a frequency of the magnetic resonance signals, and T₂ is a spin-spin relaxation time.

14. The method of claim 5, wherein the combined signal, S_{T}(t), is defined by:
$${S}_{T} ( t ) = {\sum }_{n = 1 … N} [ {w}_{n} \cdot {A}_{n} ] \cdot exp ( {ⅈφ}_{ref} ) exp [ ⅈ t ( ω - 1 / {T}_{2} ) ] ,$$
where N is a number of coils in the plurality of coils, wₙ is a weighting coefficient determined by a sensitivity of each coil, Aₙ is an amplitude coefficient, φ_{ref} is a phase of a reference signal, ω is a frequency of the magnetic resonance signals, and T₂ is a spin-spin relaxation time.

15. The method of claim 5, wherein adjusting the phase comprises:
selecting one of the magnetic resonance signals as a reference signal; and
adjusting phases of magnetic resonance signals other than the reference signal so that the phases of the magnetic resonance signals are substantially the same as a phase of the reference signal.

16. An apparatus comprising:
a magnet to produce a magnetic field;
a radio frequency signal generator to generate a radio frequency signal that excites a volume in an object to produce a magnetic resonance signal;
at least two coils to detect the magnetic resonance signal; and
a machine to process magnetic resonance signals detected by the at least two coils, the machine (i) adjusting phases of the magnetic resonance signals in the time domain to generate phase-compensated signals, and (ii) generating a combined signal based on the phase-compensated signals.

17. The apparatus of claim 16, wherein the machine further determines a frequency spectrum of the combined signal.

18. The apparatus of claim 16, wherein the machine adjusts phases of the phase-compensated signals to so that the phases of the phase-compensated signals are substantially equal to one another.

19. The apparatus of claim 16, wherein the at least two coils do not completely overlap and are placed in a vicinity of the object.

20. The apparatus of claim 16, wherein the object comprises live tissue.

21. An apparatus comprising:
means for exciting a volume to generate a magnetic resonance signal;
at least two coils for detecting the magnetic resonance signal; and
means for processing magnetic resonance signals detected by the at least two coils, the processing means (i) adjusting phases of the magnetic resonance signals to generate phase-compensated signals, and (ii) combining the phase-compensated signals to generate a combined signal.

22. The apparatus of claim 21, wherein the processing means determines a frequency spectrum of the combined signal.

23. The apparatus of claim 21, wherein the exciting means comprises:
means for generating a magnetic field; and
means for generating a radio frequency signal to excite the volume.

24. The apparatus of claim 21, wherein the phases of the phase-compensated signals are substantially equal to one another.
